(19) United States
(12) Patent Application Publication
(10) Pub. No.: US 2025/0363465 A1
(43) Pub. Date: Nov. 27, 2025

(54) SYSTEM AND METHOD FOR PLANNING TECHNICAL SERVICE TO AN AGRICULTURAL MACHINE

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,192

(22) Filed: Aug. 7, 2025

Related U.S. Application Data
(63) Continuation of application No. PCT/IB2023/061310, filed on Nov. 9, 2023.

(30) Foreign Application Priority Data
Feb. 9, 2023 (DE) 10 2023 103 208.9

(51) Int. Cl. G06Q 10/20

(52) U.S. Cl. CPC G06Q 10/20

(57) ABSTRACT

A system and method for planning technical service to at least one agricultural machine on at least one farm in a region. The system comprises a server, a database and a computational device. A module, executable by the computational device, for planning technical service to the at least one agricultural machine and a crop cultivation map for the region are stored in the database. Upon execution of the module by the computational device, the module is configured to generate a service network plan for the region to provide technical service to the at least one agricultural machine based on the crop cultivation map.

### CROSS REFERENCE TO RELATED APPLICATIONS

This application is a continuation-in-part and claims priority to PCT Application No. PCT/IB2023/061310 (published as WO/2024/165909) filed on Nov. 9, 2023, which claims priority to German Patent Application No. 10 2023 103 208.9 filed Feb. 9, 2023, the entire disclosure of both which are hereby incorporated by reference herein. This application is also related to US application No. ______ (attorney docket no. 15191-24025A (P05768/8)), US application No. ______ (attorney docket no. 15191-24026A (P05769/8)), US application No. ______ (attorney docket no. 15191-24027A (P05770/8)), US application No. ______ (attorney docket no. 15191-24028A (P05771/8)), US application No. ______ (attorney docket no. 15191-24029A (P05772/8)), US application No. ______ (attorney docket no. 15191-24030A (P05773/8)), and US application No. ______ (attorney docket no. 15191-24031A (P05774/8)), each of which are incorporated by reference herein in their entirety.

### TECHNICAL FIELD

The present invention relates to a system for planning technical service to at least one agricultural machine on at least one farm in a region and a method for planning technical service to at least one agricultural machine on at least one farm in a region.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural machines regularly need technical maintenance service, including repairs, changes of damaged and worn parts, and upgrades. Apart from such regular service checks, agricultural machines might suffer from unexpected problems while working in the harvest period of a harvest season due to broken parts. Such problems almost always lead to downtime of the agricultural machine. Downtime of agricultural machines may have significant negative impacts on farmers and agricultural operations, especially in the harvest period. When an agricultural machine is unable to perform its intended tasks, this results in decreased productivity, lost revenue, and increased operating costs. In some cases, downtime may also lead to missed deadlines for planting or harvesting crops, which may result in reduced yields and lower quality. Furthermore, prolonged downtime may result in additional wear and tear on the machine, which may further increase the likelihood of future breakdowns and reduce the lifespan of the equipment. Therefore, minimizing downtime, such as by providing technical service to an agricultural machine to minimize downtime, is crucial for maintaining the efficient and profitable operation of agricultural businesses.

So far, this technical service is often done at dedicated servicing locations. A customer owning an agricultural machine in need of such technical service transports the agricultural machine to the servicing location. A service provider at the servicing location identifies a problem, orders spare parts to repair damaged or worn components of the machine leading to the identified problem and provides the needed services to fix the problem. Afterwards, the customer may pick up the agricultural machine.

US Patent Application Publication No. 2019/0347614 A1, incorporated by reference in its entirety, discloses ordering spare parts to repair damaged components in servicing locations and to provide an autonomous supply and distribution chain management network with a focus on tracking parts and optimizing routes of parts between a source (e.g., a supplier) and a destination (e.g., a retail store or servicing location).

### BRIEF DESCRIPTION OF THE DRAWING

The present application is further described in the detailed description which follows, in reference to the noted drawing by way of non-limiting examples of exemplary embodiment, in which like reference numerals represent similar parts throughout the several views of the drawings, and wherein:

FIG. 1 illustrates an example system for planning technical service to one or more agricultural machine on one or more farms in a region.

### DETAILED DESCRIPTION

As discussed in the background, US Patent Application Publication No. 2019/0347614 A1 discloses ordering spare parts to repair damaged components in servicing locations and to provide an autonomous supply and distribution chain management network Such existing approaches do work in regions with a high quantity of servicing locations for technical service. However, there are countries or regions where such a dense network of servicing locations is not available. This is a problem, particularly in the field of agriculture. Areas that are cultivated are normally located in regions with little infrastructure and logistics, and, therefore, few servicing locations. For example, in countries like the United States, there may be regions nearly entirely composed of fields and farms cultivating lots of hectares of farmland. When it comes to technical service availability and/or spare part availability for agricultural machines, there may often be the problem that only few servicing locations are located in the entire region with distances of hundreds of kilometers in between the servicing locations and the farms. To address these challenges, the disclosed approach may perform technical services directly on the farm.

To be able to perform technical services directly on the farm, however, service networks for these regions need to be entirely reconsidered. Boundary conditions defined by the region may significantly influence the design of the service networks. Moreover, a demand for technical service may be linked to the prevailing agronomic conditions in the region. For example, an accumulation of cultivated fields in an area of the region may be directly linked to an expected demand for technical service in this area since the farms having the agricultural machines cultivating the fields are located in this area.

Therefore, it is an object of the present invention to overcome the shortcomings of the disclosed arts, such as those mentioned above. In particular, it is an object of the present invention to provide a system enabling to plan a service network for providing technical service to agricultural machines on farms in a region, whereby the service network is designed with respect to the prevailing agronomic conditions in this region. In turn, the implementation of the service network may follow in which any one, any combination, or all of spare parts, needed tools, or service technicians may be provided as part of the implementation, as discussed further below.

Thus, in one or some embodiments, a system for planning technical service to at least one agricultural machine on at least one farm in a region is disclosed. In particular, the system may comprise at least one server (such as one server), at least one database (such as one database), and at least one computational device (such as one computational device). The server, the database and the computational device may communicate (e.g., wired and/or wirelessly) with each other via one or more networks. A module for automatically planning technical service to the at least one agricultural machine and a crop cultivation map for the region may each be stored in the database. The module may be executable by the computational device, with the server hosting the module for the computational device. For example, the computational device may execute a local copy of part or all of the module, such as in the form of an app that provides a user interface to the customer, with the server hosting the module, such as responding to inquiries from the module executed on the computational device, interfacing with the database, etc. In one or some embodiments, upon execution of the module by the computational device, the module is configured to automatically generate a service network plan for the region to provide technical service to the at least one agricultural machine based on the crop cultivation map.

In one or some embodiments, the system is configured to automatically provide a recommendation of a service network for technical service of one or more agricultural machines located on one or more farms in a region that is specifically designed for this region. Especially in those regions with only few servicing locations available for technical service, it is possible due to the service network plan automatically generated by the module under consideration of the crop cultivation map to build up a service network that on the one hand serves a farmer's needs for technical service with lower (or the least) possible expenditure of time and on the other hand uses its resources efficiently (such as efficiently as possible). For example, from the crop cultivation map, areas in the region having a high accumulation of fields being cultivated with crops may be derived. From this information, the assumption may follow that a high number of agricultural machines is present in these areas to take care of the harvest process. Therefore, the service network may have a higher quantity of resources available for these areas as technical service might be needed to a higher extent in these areas than in other areas of the region. The module may automatically generate a service network plan recommending a service network for the region with a higher quantity of resources available in these high-potential areas. In turn, part or all of the service network plan may be automatically implemented, such as discussed further below. By considering the crop cultivation map, it may therefore be possible to select a finite quantity of resources to provide technical service in the region and to allocate this quantity of resources to the best located places in the region to fulfill the expected needs of the region.

In one or some embodiments, the crop cultivation map comprises agronomic information for the region, wherein the agronomic information comprises information regarding types of crops cultivated in the region and/or information regarding a distribution of crops cultivated in the region.

By including one or more different agronomic information in the crop cultivation map it may be possible to improve the data basis fed as an input into the module for automatically generating the service network plan. A better data basis may guarantee that the prevailing conditions of the region are better reflected which, in turn, may serve for providing the service network plan better adapted to the real conditions of the region. Information regarding types of crops cultivated and/or information regarding a distribution of crops cultivated may allow to better or more precisely identify high- and low-potential areas for technical service. As previously indicated, these areas may need a higher quantity of resources when building up a service network to perform technical service to agricultural machines directly on the farms in the region.

In one or some embodiments, the computational device is configured to automatically generate the crop cultivation map comprising the agronomic information for the region based on geo-referenced agronomic data available to the computational device via the network and/or via the database. The geo-referenced agronomic data may comprise any one, any combination, or all of: soil data; crop type data; crop stand data; yield data; or area data.

In one or some embodiments, the computational device is configured to consider geo-referenced climatic and weather data for automatically generating the crop cultivation map (e.g., by accessing the geo-referenced climatic and weather data and using the accessed geo-referenced climatic and weather data in order to automatically generate the crop cultivation map). The geo-referenced climatic and weather data may be available to the computational device via the network and/or via the database, wherein the geo-referenced climatic and weather data may comprise any one, any combination, or all of: precipitation data; humidity data; temperature data; solar radiation data; or wind speed data.

Using geo-referenced data may enable to link the parameters defined in the data with the specific locations the parameters were recorded at. This linkage may allow to span a data map comprising several parameters for several locations, which may allow differentiation between different areas in the region regarding the parameters (e.g., a subpart of the data map may be used for tailoring to a respective area, which is a subpart of the region). A so-called heat map may be automatically generated that may distinguish high-potential areas from low-potential areas, which may enable a precise design of the service network for the region.

In one or some embodiments, the geo-referenced agronomic data and/or the geo-referenced climatic and weather data comprises historic data.

In one or some embodiments, the computation device is configured to automatically generate the crop cultivation map comprising information regarding types of crops expected to be cultivated in the region and/or information regarding an expected distribution of the crops expected to be cultivated in the region for future harvest seasons. In this way, the module may be configured to generate the service network plan for the future harvest seasons (e.g., a predetermined further harvest season).

Using current and historic agronomic data to generate the crop cultivation map may enable automatic prediction of the agronomic conditions in the region. By having predictions for the agronomic conditions, it may be possible to pre-plan the service network for future harvest seasons (and, in turn automatically take one or more actions according to the pre-plan). Pre-planning of future harvest seasons may increase the efficiency as only few adaptations may need to be performed in case the predicted conditions deviate from the real conditions when the respective season is starting. Pre-planning may comprise any one, any combination, or all of: (i) automatically stocking a location (e.g., a central warehouse, a local warehouse closer than the central warehouse to a respective farm, a warehouse located on the farm) with one or more parts (e.g., automatically via drones and/or self-driving vehicles to transport the spare parts to the location); (ii) automatically transport needed tools to a respective location for servicing (e.g., to a location where the agricultural working machine is present, such as via self-driving vehicles); or (iii) automatically transport service technicians (e.g., via self-driving vehicles).

In one or some embodiments, the crop cultivation map may depend upon different time periods within a harvest season, wherein the time periods may comprise any one, any combination, or all of: a pre-harvest period; a harvest period; and a post-harvest period. The module may be configured to automatically generate the service network plan that varies depending upon the time period the crop cultivation map is defined for.

The need and the timeframe for technical service may vary considerably in different time periods within one single harvest season. Especially in the harvest period, a quick technical service may be needed to reduce machine downtime as much as possible. In the pre- or post-harvest period, however, there may be much more time available to fix problems agricultural machines might have. By considering different time periods and the prevailing agronomic conditions in the different time periods within one single harvest season, the flexibility of the service network may be highly increased by having the capability to shift and allocate resources (such as automatically shift and automatically allocate resources) depending on the real needs, as discussed in further detail below.

In one or some embodiments, the service network plan comprises information containing any one, any combination, or all of the following: a recommendation for a quantity and locations of central storages for spare parts for agricultural machines in the region; a recommendation for a quantity and locations of warehouses for spare parts for agricultural machines in the region; a recommendation for a quantity and types of spare parts to stock in the central storages and/or warehouses; a recommendation for a quantity and locations of service providers for providing technical service in the region; a recommendation for a quantity and locations of service vehicles for providing technical service in the region; a recommendation for a quantity and locations of part runners and/or drones in the region for transportation of spare parts between different facilities and/or entities in the region; and/or a recommendation for routes and drivetime between different facilities and/or entities in the region. Any one, any combination, or all of the recommendations may be automatically implemented, as discussed further below. In one particular example, responsive to the recommendation as to the quantity and the types of spare parts to stock, drones and/or self-driving vehicles may be used in order to implement the recommendations. In another particular example, the recommendation for the quantity and the locations of service providers for providing technical service in the region may likewise be implemented via automated self-driving vehicles. In this regard, responsive to the recommendations, one or more automated transport devices may be used in order to implement part or all of the recommendations.

Considering different entities and/or facilities as a part of the service network and providing recommendations for these different facilities and/or entities as a part of the service network plan may enable design of the service network with a high resolution providing an utmost flexibility when providing technical service.

In one or some embodiments, the module is configured to consider any one, any combination, or all of the following information available to the module via the network and/or via the database to generate the service network plan: information regarding a quantity and locations of existing central storages (e.g., actual central storages) for spare parts for agricultural machines in the region; information regarding a quantity and locations of existing warehouses (e.g., actual warehouses) for spare parts for agricultural machines in the region; information regarding a quantity and types of spare parts in stock of the central storages and/or warehouses (e.g., actual quantity and types that are currently in stock); information regarding a quantity and locations of existing service providers for providing technical service in the region; information regarding a quantity and locations of existing service vehicles for providing technical service in the region; and/or information regarding a quantity and locations of existing part runners and/or existing drones in the region for transportation of spare parts between different facilities and/or entities in the region.

In one or some embodiments, the service network plan comprises information regarding a demand for any one, any combination, or all of central storages, warehouses, spare parts, service providers, service vehicles, part runners and/or drones in the region to fulfill the recommendations for the region, the information regarding the demand being based on the recommendations and the information regarding the existing resources in the region.

Consideration of existing or current resources and including information regarding the demand of facilities and/or entities in the service network plan may enable evaluation of the quality of existing structures in the region and may reduce the amount of organization necessary to build up the recommended service network. For example, existing resources may be shifted (such as automatically shifted via automated vehicles or the like) between different locations in the region or additional personnel needs to be hired to fulfill the recommendations part of the service network plan.

In one or some embodiments, the module is configured to consider information regarding an availability of labor in the region sourced from job portals to generate the service network plan, the information being available to the module via the network and/or via the database, wherein the service network plan may comprise information regarding the quantity of labor available in the region to be hired as service providers and/or part runners.

In case personnel needs to be hired to fulfill the recommendation made by the service network plan, the possibility of screening existing job portals regarding labor available in the region may also facilitate the organizational processes necessary to build up the recommended service network in the region.

In one or some embodiments, the module is configured to consider information regarding a quantity and locations of farms having agricultural machines in the region, and potentially information regarding a quantity and configuration of agricultural machines on the farms, to generate the service network plan for the region, the information being available to the module via the network and/or via the database.

In one or some embodiments, the service network plan comprises a map of the region visualizing the service network recommended to provide technical service.

Having a visualization tool to illustrate the service network may assist the process of building up the service network in the region and, in addition, may be shown and serve to convince a farmer or customer of agricultural machines in relying in the concept of providing technical service to agricultural machines directly on farms.

In one or some embodiments, the module is configured to store the service network plan in the database and/or to distribute the service network plan to different facilities and entities via the network.

In one or some embodiments, a method is disclosed for planning technical service to at least one agricultural machine on at least one farm in a region. Therefore, the present invention may also relate to a method for planning technical service to at least one agricultural machine on at least one farm in a region using a system. The system comprises at least one server, at least one database, and at least one computational device, wherein the server, the database and the computational device communicate with each other via one or more networks. A module for planning technical service to the at least one agricultural machine and a crop cultivation map for the region may be stored in the database. The module is executable by the computational device, wherein the server is hosting the module for the computational device. Upon execution of the module by the computational device, a service network plan for the region to provide technical service to the at least one agricultural machine is automatically generated by the module based on the crop cultivation map.

One, some or each feature disclosed with regard to the system are equally applicable to the method.

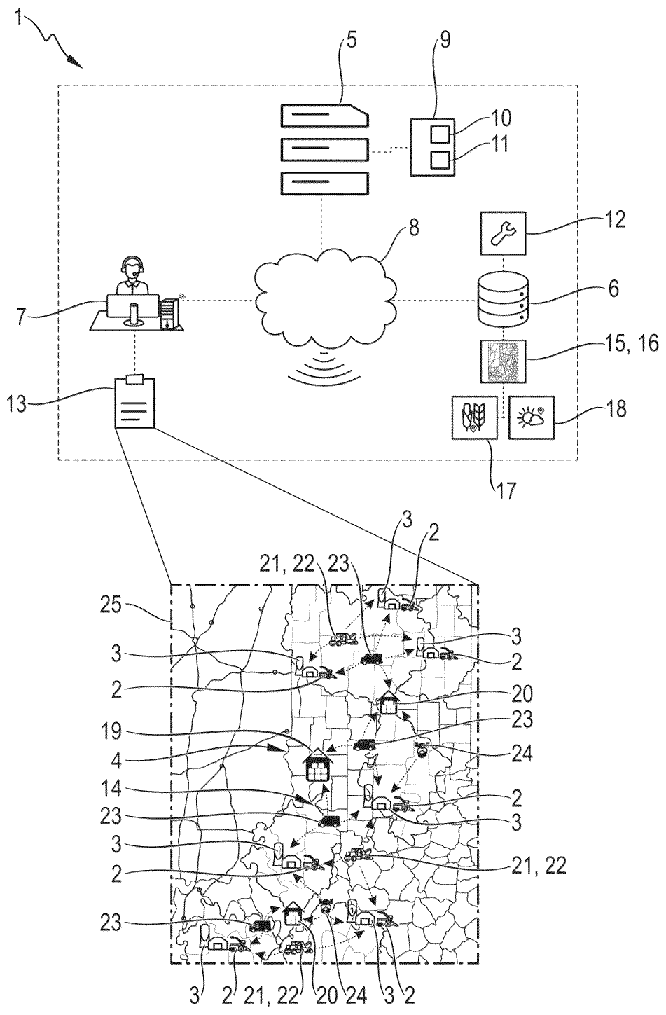

Referring to the figures, FIG. 1 illustrates a system 1 for planning technical service to one or more agricultural machine 2 on one or more farms 3 in a region 4. The one or more agricultural machines 2 may comprise one or more tractors, one or more forage harvesters, one or more combine harvesters, one or more agricultural balers or the like.

The system 1 comprises a server 5, a database 6 and a computational device 7 which may be configured as a personal computer, tablet or the like. The server 5, the database 6 and the computational device 7 are communicatively connected to each other via a network 8, the network 8, thus, enables an exchange of information and data between the different devices 5, 6, 7.

The server 5 may comprise a processing device 9 which enables processing of the data and information exchanged between the server 5, the database 6 and/or the computational device 7. The processing device 9 may comprise any type of computing functionality, such as at least one processor 10 (which may comprise a microprocessor, controller, PLA, or the like) and at least one memory 11. The memory 11 may comprise any type of storage device (e.g., any type of memory). Though the processor 10 and the memory 11 are depicted as separate elements, they may be part of a single machine, which includes a microprocessor (or other type of controller) and a memory. Alternatively, the processor 10 may rely on memory 11 for all of its memory needs.

The processor 10 and memory 11 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the processing device 9 which may comprise the at least one processor 10 and the at least one memory 11 may be applied to other devices, such as the computational device 7 mentioned above.

A module 12 for planning technical service to the one or more agricultural machines 2 is stored in the database 6 and configured to be executed by the computational device 7. The module 12 is hosted for the computational device 7 by the server 5, wherein upon execution of the module 12 by the computational device 7 the module 12 is configured to generate a service network plan 13 for the region 4 to provide technical service to the one or more agricultural machines 2. The service network plan 13 defines a recommendation of a service network 14 for the region 4 that serves the needs to provide technical service for the one or more agricultural machines 2 located on the one or more farms 3 in the region 4. Execution of and interaction with the module 12 by the computational device 7 is possible, for example, via an application which is configured to run on the computational device 7. For generating the service network plan 13, the module 12 may use computational resources provided by one or more internal processing devices of the computational device 7 and/or computational resources provided by the processing device 9. To generate the service network plan 13 for the region 4, the module 12 is configured to access specific information. Such information is defined in a crop cultivation map 15 for the region 4, the crop cultivation map 15 being stored in the database 6 and available to the computational device 7 respectively to the module 12 via the network 8. To enable the module 12 to generate the service network plan 13 for the region 4 the crop cultivation map 15 may be processed by the one or more internal processing devices of the computational device 7 and/or the processing device 9. The processing devices may use different methods or algorithms for processing the crop cultivation map 15, in particular the information contained in the crop cultivation map 15, for the sake of generating the service network plan 13 for the region 4. Some or all of these methods or algorithms may be based on artificial intelligence (AI). Preferably the processing is based on recourses provided by a neural network.

To be able to recommend a service network 14 that is as well adapted as possible to the prevailing agronomic conditions in the region 4 focused on it may be beneficial that the crop cultivation map 15 defining the input for the module 12 contains different types of agronomic information 16 for the region 4. The crop cultivation map 15 may comprise information regarding types of crops cultivated in the region 4. Alternatively or in addition, the crop cultivation map 15 may comprise information regarding a distribution of crops cultivated in the region 4. The computational device 7 may be configured to generate the crop cultivation map 15 and to store the crop cultivation map 15 in the database 6 prior to be used by the module 12 to generate the service network plan 13. Alternatively, the crop cultivation map 15 may be pre-generated by any other device or service provider independent of the system 1 and stored in the database 6. However, in any case, the crop cultivation map 15 containing the agronomic information 16 may be generated based on geo-referenced agronomic data 17. In case the computational device 7 is generating the crop cultivation map 15, the geo-referenced agronomic data 17 is made available to the computational device 7 via the database 6, if the database 6 is storing the geo-referenced agronomic data 17, and/or via the network 8 from any source. The geo-referenced agronomic data 17 may comprise one or more of soil data, crop type data, crop stand data, yield data, area data or the like.

In order to get a more precise and accurate crop cultivation map 15 additional data may be considered for generating the crop cultivation map 15. Besides from geo-referenced agronomic data 17, the crop cultivation map 15 may be based on geo-referenced climatic and weather data 18. Therefore, when the computational device 7 may generated the crop cultivation map 15 prior to a usage by the module 12 to generate the service network plan 13, the computational device 7 may generate the crop cultivation map 15 based on the geo-referenced climatic and weather data 18 which is equally made available to the computational device 7 via the database 6, if the database 6 is storing the geo-referenced climatic and weather data 18, and/or via the network 8 from any source. The geo-referenced climatic and weather data 18 may comprise one or more of precipitation data, humidity data, temperature data, solar radiation data, wind speed data or the like.

The geo-referenced agronomic data 17 and/or the geo-referenced climatic and weather data 18 may not only be current data, but also historic data from preceding time periods. This enables to generate a crop cultivation map 15 for the region 4 including agronomic information 16 for different time periods. Having either current agronomic information 16 and agronomic information 16 for preceding time periods available may enable the computational device 7 to generate the crop cultivation map 15 comprising agronomic information 16 for future harvest seasons. In particular, the computational device 7 may be configured to generate the crop cultivation map 15 comprising information regarding types of crops expected to be cultivated in the region 4 for future harvest seasons. Alternatively or in addition, the computational device 7 may be configured to generate the crop cultivation map 15 comprising information regarding an expected distribution of the crops expected to be cultivated in the region 4 for future harvest seasons. Based on the information for future harvest seasons contained in the crop cultivation map 15, the module 12 may be configured to generate the service network plan 13 for the future harvest seasons. Generating service network plans 13 for future harvest seasons enables to pre-plan the service network 14 in the region 4 that is needed in future harvest seasons to provide technical service to one or more agricultural machines 2 on one or more farms 3 in the region 4. When the status of a harvest season changes from future harvest season to current harvest season, the module 12 may be configured to re-plan or adapt the service network plan 13 already available for this harvest season based on an adapted crop cultivation map 15 containing the agronomic information 16 prevailing at that point in time.

However, the crop cultivation map 15 may not only be able to provide agronomic information 16 for future harvest season, but may also reflect different time periods within one single harvest season. In other words, the crop cultivation map 15 may comprise agronomic information 16 for different time periods in one single harvest season. The time periods within one single harvest season may be clustered into a pre-harvest period, a harvest period and a post-harvest period. In each of these periods within one single harvest season the needs for technical service in the region 4 may be different so that a different design of the service network 14 may be beneficial. Therefore, the module 12 may be configured to generate the service network plan 13 that varies depending upon the time period the crop cultivation map 15 is defined for.

As already addressed, the service network plan 13 generated by the module 12 defines a recommendation of a service network 14 for the region 4 that serves the needs to provide technical service for the one or more agricultural machines 2 located on the one or more farms 3 in the region 4. To define a general recommendation of a service network 14 the service network plan 13 may comprise different information related to the service network 14 that is recommended to be built up in the region 4, the information being in the form of sub-recommendations covering different entities and/or facilities, so-called resources, necessary to build up a service network 14 to provide technical service to one or more agricultural machines 2 on one or more farms 3 in the region 4. In more detail, the information may comprise one or more of a recommendation for a quantity and locations of central storages 19 for spare parts for the agricultural machines 2 in the region 4, a recommendation for a quantity and locations of warehouses 20 for spare parts for the agricultural machines 2 in the region 4, a recommendation for a quantity and types of spare parts to stock in the central storages 19 and/or warehouses 20, a recommendation for a quantity and locations of service providers 21 for providing technical service in the region 4, a recommendation for a quantity and locations of service vehicles 22 for providing technical service in the region 4, a recommendation for a quantity and locations of part runners 23, wherein a part runner 23 may either be a vehicle driven by a human or an autonomous vehicle, and/or drones 24 in the region 4 for transportation of spare parts between different the facilities and/or entities in the region 4 and/or a recommendation for routes and drivetime between different the facilities and/or entities in the region 4. Having these different types of sub-recommendations contained in the service network plan 13 a general recommendation for the service network 14 containing one or more of the entities and/or facilities mentioned may be defined that enables to provide technical service for agricultural machines 2 on farms 3 in the region 4 covering the needs of the farmers/customers owning and/or operating the agricultural machines 2.

However, it may be beneficial for generating the service network plan 13 containing the recommendations that the module 12 considers additional information which is made available to the module 12 via the database 6 and/or the network 8 besides the information available from the crop cultivation map 15. Such information may be related to existing entities and/or facilities, the so-called resources, in the region 4 that may be used to build up the service network 14. In particular, the module 12 may consider one or more of information regarding a quantity and locations of existing central storages 19 for spare parts for agricultural machines 2 in the region 4, information regarding a quantity and locations of existing warehouses 20 for spare parts for agricultural machines 2 in the region 4, information regarding a quantity and types of spare parts in a stock of the central storages 19 and/or warehouses 20, information regarding a quantity and locations of existing service providers 21 for providing technical service in the region 4, information regarding a quantity and locations of existing service vehicles 22 for providing technical service in the region 4 and/or information regarding a quantity and locations of existing part runners 23 and/or existing drones 24 in the region 4 for transportation of spare parts between the different facilities and/or entities in the region 4.

A considering of the existing resources available in the region 4 enables the module 12 to generate the service network plan 13 comprising information regarding a demand for one or more of central storages 19, warehouses 20, spare parts, service providers 21, service vehicles 22, part runners 23 and/or drones 24 in the region 4 to fulfill the different recommendations for the region 4 part of the service network plan 13. The information regarding the demand may be generated by considering the recommendations for the different entities and/or facilities (resources) in the region 4 and the information regarding the existing entities and/or facilities (recourses) in the region 4. Apart from reflecting a demand for entities and/or facilities in the service network plan 13, the module 12 may be configured to consider information regarding an availability on labor in the region 4 the service network 14 should be defined for. The information regarding the availability of labor may be sourced from job portals and may be available to the module 12 via the network 8 and/or via the database 6. Based the information regarding available labor in the region 4 considerable by the module 12 as well as the recommendations for the region 4 and/or the information regarding existing resources in the region 4, the service network plan 13 may comprise an information regarding the quantity of labor available in the region 4 that could be hired as service providers 21 and/or part runners 23.

Besides from the mentioned information to be considered by the module 12 to generate the service network plan 13, it may be beneficial that the module 12 considers additional information regarding or related to a quantity and locations of farms 3 having agricultural machines 2 in the region 4. Alternatively or in addition, the module 12 may consider information regarding or related to a quantity and configuration of agricultural machines 2 on the farms 3. As all the other information considered by the module 12, the information may be available to the module 12 via the network 8 and/or via the database 6. Based on the recommendations for the entities and/or facilities (resources) in the region 4 and or the information related to the farms 3 and the agricultural machines 2 on the farms 3 in the region 4, the module 12 may be configured to generate the service network plan 13 that comprises a map 25 of the region 4 visualizing the service network 14 that is recommended for the region 4 to provide technical service to the agricultural machines 2 on the farms 3 in the region 4. A schematic and exemplary view of the map 25 is shown in FIG. 1.

In general, the module 12 may be configured to automatically store the service network plan 13 generated in the database 6 of the system 1. Alternatively or in addition, the module 12 may be configured to automatically distribute the service network plan 13 to any facility and/or entity via the network 8 so that the respective facility and/or entity is informed about how the service network 14 should be configured in the region 4 to provide the technical service.

In one or some embodiments, using the module 12, it may be possible to automatically plan a service network 14 to offer technical service to agricultural machines 2 on farms 3 in regions 4, particularly in those regions 4 with only few servicing locations available for technical service. By automatically considering the crop cultivation map 15 to generate the service network plan 13 the service network 14 recommended may be automatically adapted or modified to the prevailing agronomic conditions in the respective region 4 focused on. In this regard, not only a farmer's need for technical service to agricultural machines 2 may therefore be met with less or the least possible expenditure of time, but also the technical service itself including all the necessary resources may be utilized in an efficient manner.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 System for planning technical service
2 Agricultural machine
3 Farm
4 Region
5 Server
6 Database
7 Computational device
8 Network
9 Processing device
10 Processor
11 Memory
12 Module
13 Service network plan
14 Service network
15 Crop cultivation map
16 Agronomic information
17 Geo-referenced agronomic data
18 Geo-referenced climatic and weather data
19 Central storage
20 Warehouse
21 Service provider
22 Service vehicle
23 Part runner
24 Drone
25 Map

1. A system for planning technical service to at least one agricultural machine on at least one farm in a region, the system comprising:
at least one server;
at least one database; and
at least one computational device;
wherein the at least one server, the at least one database, and the at least one computational device are configured to communicate via one or more networks;
wherein the at least one database is configured to store a module and a crop cultivation map for the region, wherein the module is configured to plan technical service for the at least one agricultural machine;
wherein the at least one server is configured to host the module for the at least one computational device;
wherein, upon execution of the module by the computational device, the module is configured to automatically generate, based on the crop cultivation map, a service network plan for the region in order to provide the technical service to the at least one agricultural machine.

2. The system of claim 1, wherein the crop cultivation map comprises agronomic information for the region;
wherein the agronomic information comprises one or both of information regarding types of crops cultivated in the region or information regarding a distribution of crops cultivated in the region; and
wherein the module is configured to automatically generate the service network plan for the region based on the one or both of the information regarding types of crops cultivated in the region or the information regarding a distribution of crops cultivated in the region.

3. The system of claim 2, wherein the agronomic information comprises both of the information regarding types of crops cultivated in the region or the information regarding a distribution of crops cultivated in the region; and
wherein the module is configured to automatically generate a service network plan for the region based on both of the information regarding types of crops cultivated in the region or the information regarding a distribution of crops cultivated in the region.

4. The system of claim 2, wherein the at least one computational device is configured to:
automatically access geo-referenced agronomic data from one or both of the one or more networks or the at least one database, wherein the geo-referenced agronomic data comprises one or more of soil data, crop type data, crop stand data, yield data, or area data; and
automatically generate, based on the geo-referenced agronomic data, the crop cultivation map comprising the agronomic information for the region.

5. The system of claim 4, wherein the geo-referenced agronomic data comprises historic data.

6. The system of claim 2, wherein the at least one computational device is configured to:
automatically access geo-referenced climatic and weather data from one or both of the one or more networks or the at least one database, wherein the geo-referenced climatic and weather data comprises one or more of precipitation data, humidity data, temperature data, solar radiation data, or wind speed data; and
automatically generate, based on the geo-referenced climatic and weather data, the crop cultivation map comprising the agronomic information for the region; and
wherein one or both of the at least one server or the at least one computational device is further configured to automatically provide, based on the service network plan, the technical service to the at least one agricultural machine.

7. The system of claim 6, wherein the geo-referenced climatic and weather data comprises historic data.

8. The system of claim 2, wherein the at least one computation device is configured to generate the crop cultivation map comprising one or both of information regarding types of crops to be cultivated in the region for one or more future harvest seasons or information regarding an expected distribution of the crops to be cultivated in the region for the one or more future harvest seasons; and
wherein the module is configured to automatically generate, using the crop cultivation map, the service network plan for the one or more future harvest seasons.

9. The system of claim 2, wherein the crop cultivation map depends upon a plurality of different time periods within a respective harvest season;
wherein the plurality of different time periods comprise a pre-harvest period, a harvest period and a post-harvest period;
wherein the module is configured to automatically generate the service network plan that varies depending upon a respective time period, selected from the plurality of different time periods, the crop cultivation map is defined for; and
wherein one or both of the at least one server or the at least one computational device is further configured to:
automatically determine a current time period;
automatically determine, based on the current time period, the respective time period that is selected from the plurality of different time periods;
automatically determine, based on the respective time period, a subpart of the service network plan in order to provide the technical service to the at least one agricultural machine; and
automatically provide, based on the subpart of the service network plan, the technical service to the at least one agricultural machine.

10. The system of claim 2, wherein the service network plan comprises information containing one or more of the following:
a recommendation for a quantity and one or more locations of central storages for spare parts for agricultural machines in the region;
a recommendation for a quantity and one or more locations of warehouses for spare parts for agricultural machines in the region;
a recommendation for a quantity and types of spare parts to stock in one or both of the one or more central storages or the one or more warehouses;
a recommendation for a quantity and locations of service providers for providing technical service in the region;
a recommendation for a quantity and locations of service vehicles for providing technical service in the region;
a recommendation for a quantity and locations of one or both of part runners or drones in the region for transportation of the spare parts within in the region; or
a recommendation for routes and drivetime within the region; and
wherein one or both of the at least one server or the at least one computational device is further configured to:
automatically access the service network plan;
automatically provide, based on the service network plan, the technical service to the at least one agricultural machine.

11. The system of claim 10, wherein the module is configured to:
access information regarding one or of:
the quantity and the locations of one or more existing central storages for the spare parts for the agricultural machines in the region;
the quantity and the locations of one or more existing warehouses for the spare parts for the agricultural machines in the region;
the quantity and types of the spare parts in the stock of one or both of the one or more existing central storages or the one or more existing warehouses;
the quantity and the locations of existing service providers for providing technical service in the region;
the quantity and the locations of existing service vehicles for providing the technical service in the region; or
the quantity and the locations of one or both of existing part runners or existing drones in the region for transportation of spare parts within in the region; and
automatically generate, based on the information, the service network plan; and
wherein one or both of the at least one server or the at least one computational device is further configured to:
automatically access the service network plan;
automatically provide, based on the service network plan, the technical service to the at least one agricultural machine.

12. The system of claim 11, wherein the service network plan comprises information regarding one or more of:
a demand for the one or more existing central storages, the one or more existing warehouses, the spare parts in the stock, the existing service providers, the existing service vehicles, the existing part runners, or the existing drones in the region to fulfill the recommendations for the region;
wherein the demand is on the recommendations and the information regarding existing resources in the region, including one or more of the one or more existing central storages, the one or more existing warehouses, the spare parts in the stock, the existing service providers, the existing service vehicles, the existing part runners, or the existing drones.

13. The system of claim 10, wherein the module is configured to:
automatically access, via the one or more networks or the at least one database, information regarding availability of labor in the region sourced from job portals; and
automatically generate, using the information regarding the availability of labor in the region, the service network plan, wherein the service network plan comprises information regarding quantity of the labor available in the region to be hired as one or both of the service providers or the part runners.

14. The system of claim 1, wherein the module is configured to:
automatically access, via the one or more networks or the at least one database, information regarding quantity and locations of farms having agricultural machines in the region; and
automatically generate, using the information regarding the quantity and the locations of farms having agricultural machines in the region, the service network plan.

15. The system of claim 14, wherein the module is configured to:
automatically access, via the one or more networks or the at least one database, information regarding the quantity and configuration of the agricultural machines on the farms; and
automatically generate, using the information regarding the quantity and configuration of the agricultural machines on the farms, the service network plan.

16. The system of claim 1, wherein the service network plan comprises a map of the region visualizing the service network as recommended to provide technical service; and
wherein one or both of the at least one server or the at least one computational device is further configured to:
automatically access the service network plan;
automatically output the map of the region visualizing the service network;
automatically provide, based on the service network plan, the technical service to the at least one agricultural machine.

17. The system of claim 1, wherein the module is configured to perform one or both of: store the service network plan in the at least one database; or distribute the service network plan to one or more facilities or entities via the one or more networks; and
wherein at least one electronic device is configured to:
automatically access the service network plan;
automatically provide, based on the service network plan, the technical service to the at least one agricultural machine.

18. A method for planning technical service for at least one agricultural machine on at least one farm in a region, the method comprising:
using a system comprising at least one server, at least one database, and at least one computational device, wherein the at least one server, the at least one database, and the at least one computational device communicate via one or more networks, wherein the at least one database has stored a module and a crop cultivation map for the region, wherein the module is configured to plan technical service for the at least one agricultural machine, wherein the at least one server is configured to host the module for the at least one computational device; and
upon execution of the module by the computational device, the module automatically generates, based on the crop cultivation map, a service network plan for the region in order to provide the technical service to the at least one agricultural machine.

19. The method of claim 18, wherein the crop cultivation map comprises agronomic information for the region;
wherein the agronomic information comprises one or both of information regarding types of crops cultivated in the region or information regarding a distribution of crops cultivated in the region; and
wherein the module automatically generates the service network plan for the region based on the one or both of the information regarding types of crops cultivated in the region or the information regarding a distribution of crops cultivated in the region.
